(19) United States
(12) Patent Application Publication
(10) Pub. No.: US 2015/0223435 A1
(43) Pub. Date: Aug. 13, 2015

(54) EGG SETTLEMENT INDUCING SUBSTRATE FOR SHELLFISH, AND SHELLFISH SEED COLLECTION METHOD AND CULTURE METHOD USING SAME

(71) Applicants: ISHII CORPORATION, Takasaki-shi, Gunma (JP); NATIONAL INSTITUTE OF TECHNOLOGY, Hachioji-shi, Tokyo (JP)

(72) Inventors: Akira Kojima, Kiryu-shi (JP); Masao Fujishige, Maebashi-shi (JP); Toshiaki Ishii, Takasaki-shi (JP)

(73) Assignees: NATIONAL INSTITUTE OF TECHNOLOGY, Hachioji-shi, Tokyo (JP); ISHII CORPORATION, Takasaki-shi, Gunma (JP)

(21) Appl. No.: 14/608,582

(22) PCT Filed: May 17, 2013
(86) PCT No.: PCT/JP2013/064542

§ 371 Date: Jan. 29, 2015

(30) Foreign Application Priority Data
Jul. 30, 2012 (JP) 2012-168849

(51) Int. Cl. A01K 61/00

(52) U.S. Cl. CPC A01K 61/002

(57) ABSTRACT

An egg settlement inducing substrate for shellfish includes: an iron member containing metallic iron; and a carbon member constituting an egg settlement inducing portion, wherein the carbon member is provided on an outer periphery of the iron member so that the carbon member and the metallic iron in the iron member are at least partly in contact with each other. This egg settlement inducing substrate has high and stable seed collection efficiency, and also the time for installing the egg settlement inducing substrate does not depend on the time of spawning and emergence of larvae in the settlement period.

### TECHNICAL FIELD

The present invention relates to an egg settlement inducing substrate for shellfish suitably used in a shellfish seed collection site, and a shellfish seed collection method and a shellfish culture method using the egg settlement inducing substrate.

### BACKGROUND

In Japan where aquatic resources are limited, shellfish such as oysters are cultured nationwide.

For example, at least 20 varieties are known for oysters alone, which are cultured in many parts of the country. Different culture methods are employed in different production area. Of these, a typically employed method is the following. Natural oyster eggs (including larvae) drifting in the sea are allowed to attach to an egg settlement inducing substrate (for seed collection), to develop into oyster spat. The oyster spat are then suspended from a raft, and further grown for two to three years. The seed collection method used in this case is to timely suspend scallop shells as the egg settlement inducing substrate down into the water at the spawning time of oysters so that eggs are attached to the scallop shells.

Scallop shells to which released eggs attach are used from experience and tradition. Other egg settlement inducing substrates include bamboos, seashells, roofing tiles, concrete, plastic, and the like, though scallop shells are most commonly used in Japan.

### CITATION LIST

### Patent Literatures

PTL 1: JP 2009-297622 A

PTL 2: JP 2001-136861 A

### SUMMARY

While Japanese oyster (Crassostrea gigas), for example, is a dioecious oviparous species and is known to spawn around August, it has been problematic that the spawning date and time cannot be exactly predicted and there is no choice but to rely on experiences. Besides, although an area where many natural eggs and juvenile larvae of oysters gather is selected to place the egg settlement inducing substrate, efficient seed collection cannot be expected unless certain requirements such as water temperature and water flow velocity are satisfied.

It is extremely difficult to determine when to install the egg settlement inducing substrate, as mentioned above.

A current practice for determining the time for installing the egg settlement inducing substrate is to firstly confirm an oyster spawning date, and then estimate a date that the eggs attach to the substrate from daily changes in water temperature. During several days before and after the estimated attaching date, drifting larvae are collected with a plankton net or the like, and the number of larvae and their growth states are measured. Upon determining that many drifting larvae have emerged, the egg settlement inducing substrate is introduced.

However, the scallop shells used as the egg settlement inducing substrate as mentioned above are natural products that are hard to be provided with uniform shape and size, and thus the seed collection rate is not very high. Moreover, the scallop shells to be installed in the sea as the egg settlement inducing substrate need to have clean surfaces. Besides, the installation needs to be done immediately before the spawning of oysters as mentioned above. This is because, if the substrate is installed long before the spawning, other creatures attach to the substrate and obstruct the attachment of oyster eggs.

Further, under the current circumstances, it is impossible to accurately forecast the spawning of oysters and the emergence of drifting larvae as they are complexly affected by various conditions such as weather, water temperature, and the moon phase. Hence, the determination of the scallop shell placement (installation) time according to the conventional practice heavily relies on experiences and intuition.

Fishermen are likely to suffer a loss as high as billions of yen in the case of a failure of seed collection. Therefore, it will be greatly beneficial to fishermen if simple and efficient measures allowing oyster eggs to attach to the substrate is available. Moreover, if seed collection can be performed even with an egg settlement inducing substrate installed beforehand regardless of the spawning time, the time and effort required for oyster culture can be saved significantly, which contributes to very stable and smooth production.

The present invention has been developed in view of the circumstances described above, and aims to provide an egg settlement inducing substrate for shellfish that has very high and stable seed collection efficiency and allows the time of its installation to be independent from the time of spawning and emergence of juvenile larvae, and a shellfish seed collection method and culture method using the egg settlement inducing substrate.

As a result of repeating intensive studies to solve the problem stated above, the present inventors have found an egg settlement inducing substrate for shellfish having a very high seed collection effect and a very wide range of egg settlement inducing substrate introduction time, together with a shellfish seed collection method and culture method using the egg settlement inducing substrate.

The present invention has been completed based on these findings.

The summary and construction of the invention are as follows

(1) An egg settlement inducing substrate for shellfish, including: an iron member containing metallic iron; and a carbon member constituting an egg settlement inducing portion, wherein the carbon member is provided on an outer periphery of the iron member so that the carbon member and the metallic iron in the iron member are at least partly in contact with each other.

(2) The egg settlement inducing substrate for shellfish according to the item (1), wherein the shellfish is an oyster.

(3) The egg settlement inducing substrate for shellfish according to the item (1) or (2), wherein the iron member is at least partly coated with zinc.

(4) The egg settlement inducing substrate for shellfish according to any one of the items (1) to (3), further including a binding member that binds the carbon member and the iron member together.

(5) The egg settlement inducing substrate for shellfish according to the item (4), wherein the binding member has at least one shape selected from a net, a lattice, and a blind.

(6) The egg settlement inducing substrate for shellfish according to any one of the items (1) to (5), wherein the carbon member is made of at least one material selected from charcoal, bamboo charcoal, carbon fiber-reinforced plastic, an expanded graphite sheet, carbon fiber cloth, and a graphite material.

(7) The egg settlement inducing substrate for shellfish according to any one of the items (1) to (6), wherein the carbon member has surface roughness of not less than 0.5 μm in arithmetic mean roughness.

(8) The egg settlement inducing substrate for shellfish according to any of the foregoing 1 to 7, wherein the iron member has an Fe content of not less than 5 mass %.

(9) The egg settlement inducing substrate for shellfish according to any one of the items (1) to (8), wherein the iron member has a cylindrical shape and is situated at a center of the egg settlement inducing substrate, and the carbon member has at least one shape selected from a strip, a mesh, a line, and a rod is provided on the outer periphery of the iron member.

(10) The egg settlement inducing substrate for shellfish according to any one of the items (1) to (9), wherein both of the iron member and the carbon member have a rod shape.

(11) The egg settlement inducing substrate for shellfish according to any one of the item (1) to (10), further comprising a self-shrinkable lashing member wrapping around the egg settlement inducing substrate.

(12) A method of collecting shellfish seeds, comprising suspending the egg settlement inducing substrate for shellfish according to any one of the items 1 to 11 down to at least one location in any of brackish water and seawater.

(13) A method of culturing shellfish, comprising: placing the shellfish collected by the method according to the item 12 within a range where iron ion eluted from the egg settlement inducing substrate for shellfish according to any one of the items 1 to 11 reaches.

According to the present invention, the seed collection efficiency can be very high, so that the egg settlement inducing substrate can be placed even in an area where natural seed collection has conventionally been impossible. In addition, the time for the egg settlement inducing substrate installation does not depend on the spawning time, which significantly simplifies management of the time for installation and the like.

Moreover, according to the present invention, shellfish seed collection and culture can be conducted very stably and smoothly.

### BRIEF DESCRIPTION OF THE DRAWINGS

The present invention will be further described below with reference to the accompanying drawings, wherein:

FIG. 1 is a conceptual diagram of an egg settlement inducing substrate according to the present invention;

FIG. 2 is a conceptual diagram illustrating an example of the structure of the egg settlement inducing substrate according to the present invention;

FIG. 3 is a view illustrating an example of the egg settlement inducing substrate according to the present invention;

FIG. 4 is a diagram illustrating another example of the structure of the egg settlement inducing substrate according to the present invention;

FIG. 5 is a diagram illustrating a procedure of assembling the egg settlement inducing substrate according to the present invention;

FIG. 6 is a view illustrating a raft from which the egg settlement inducing substrate is suspended;

FIG. 7 is a view illustrating the entire egg settlement inducing substrate to which oysters (growth duration of 1 year) attach;

FIG. 8 is an enlarged view illustrating oysters (growth duration of 1 year) adhering to the egg settlement inducing substrate;

FIG. 9 is a view illustrating oysters (growth duration of 1 year) adhering to and growing on the egg settlement inducing substrate;

FIG. 10 is a view illustrating parts of contact between a zinc coated iron member and carbon fiber woven fabric; and

FIG. 11 is a view illustrating objects such as oysters adhering to the carbon fiber woven fabric suspended from the raft.

### DETAILED DESCRIPTION

The following describes the present invention in detail.

As illustrated in FIG. 1, an egg settlement inducing substrate for shellfish according to the present invention includes an iron member containing metallic iron and a carbon member constituting an egg settlement inducing portion, as main components. The carbon member is provided on the outer periphery of the iron member so that the carbon member and the metallic iron in the iron member are at least partly in contact with each other. This significantly increases the margin of the introduction time. In the present invention, the subject of seed collection is not limited to pure eggs, but includes larvae in the settlement period. In other words, egg settlement denotes the attachment of eggs and/or larvae of shellfish. Oysters are the most preferable shellfish intended to attach to the egg settlement inducing substrate, for the development of the settlement effect.

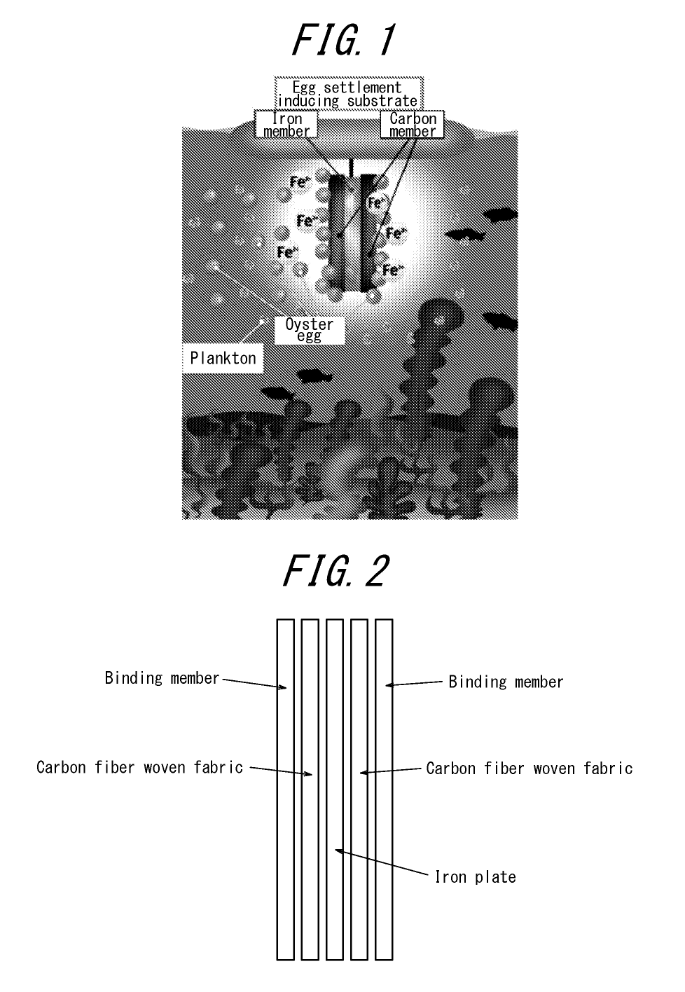

In the case of using the egg settlement inducing substrate for shellfish according to the present invention in seawater, the egg settlement inducing substrate for shellfish is typically used over a long period of time, e.g. in years. It is therefore preferable to use a binding member as illustrated in FIGS. 2 and 3. This is because the egg settlement inducing substrate for shellfish according to the present invention has no particular maintenance problem in months but degrades in performance or deactivates over time in seawater.

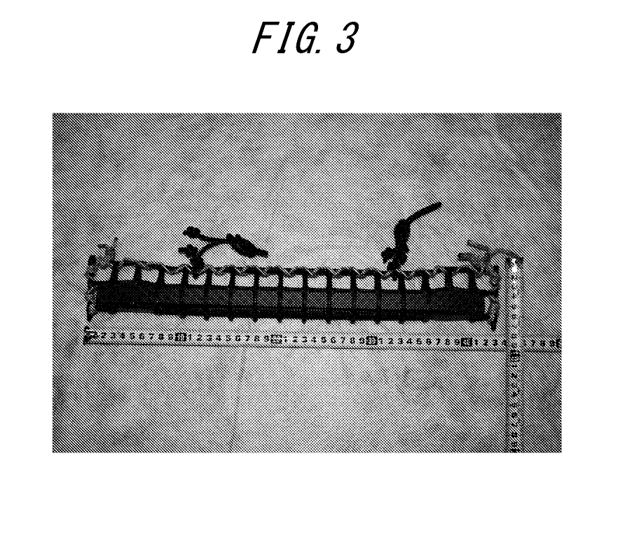

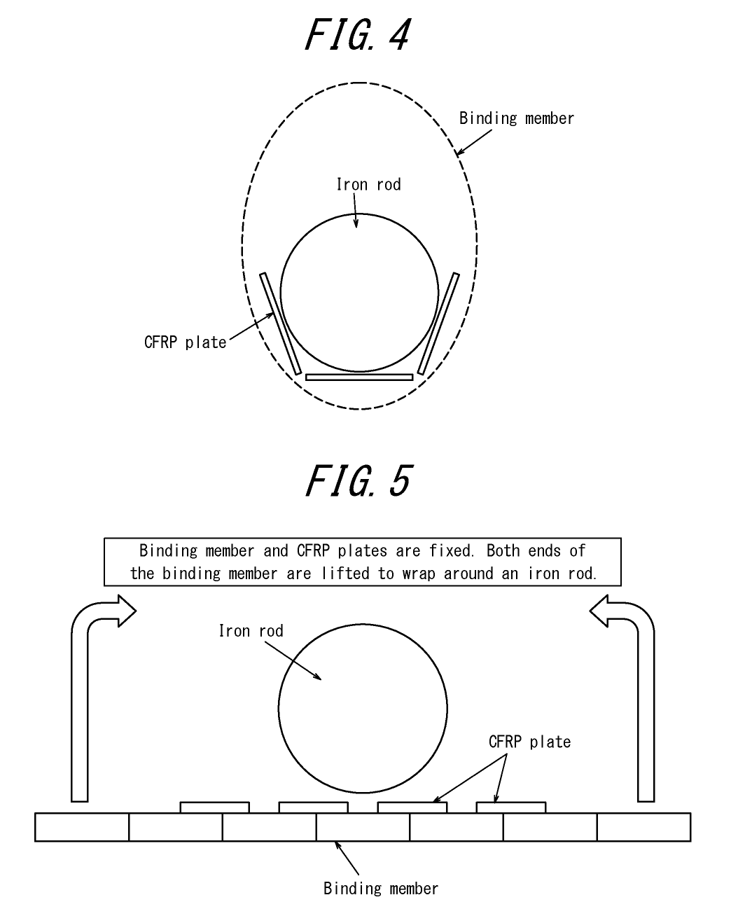

FIGS. 4 and 5 illustrate an example of the structure of the binding member. As illustrated in FIG. 5, the binding member and a CFRP plate (carbon member) are fixed together, and both ends of the binding member are lifted to wrap around an iron rod (iron member), thus forming the egg settlement inducing substrate according to the present invention.

The shape of the binding member is preferably selected from, but is not limited to, a net, a lattice, and a blind, and may be any combination of these shapes. The binding member may be a film or a plate obtained by punching out the base member into any shape. The punched shape may be a circle, a triangle, a polygon, a star, a rhombus, a slit, or a dot.

The binding member is not particularly limited so long as it is resistant to seawater, i.e. it is usable in seawater. Preferable examples of the binding member include chemical fiber or syntactic resin such as polyethylene, nylon, Tetoron®, and Saran®.

In freshwater, the above-mentioned phenomenon of reduction in performance does not occur, but the binding member may be used for an improvement in the stability of the advantageous effect.

The iron member used in the present invention may be coated with zinc on at least a part of its surface. The provision of the zinc coating not only increases the anticorrosion property of the iron member, but also effectively increases zinc which is a mineral in oysters during culture of oysters.

The zinc coating preferably occupies a range of not less than 1% of the iron member surface. If the coating range is less than 1%, there is a possibility that a sufficient iron elution effect by the present invention cannot be attained. Though the upper limit of the coating range may be 100%, about 90% is preferable in terms of securing an iron elusion surface. A preferable range is from 40% to 95%. The shape of the coating is not particularly limited, and may be a dot shape or a lattice shape.

Various methods are available to coat the iron member with zinc, and the thickness of the zinc layer is selected as appropriate depending on the raw material, shape, and method used. Preferably, the thickness of the plating layer is about 10 μm to 125 μm for hot-dip galvanization, about several μm to 25 μm for electrogalvanization, about 75 μm to 125 μm for zinc spraying, and about 10 μm to 35 μm for zinc dust paint coating. A zinc plating layer of a typical zinc iron plate has the thickness of about several μm to 20 μm, and may be used in the present invention. In some products, the zinc layer contains aluminum. Any of the above-mentioned various structures commonly produced may be used as the zinc coated iron plate in the present invention, to improve the corrosion resistance of the iron member.

The carbon member constituting the egg settlement inducing portion used in the present invention is not particularly limited so long as it is made of a carbon element-containing material having electrical conductivity. Examples of such carbon material include carbon fiber, charcoal, bamboo charcoal, graphite, carbon black, a carbon material for electrodes, and a compound thereof. The electrical conductivity is not particularly limited, but is preferably not greater than about 10³ Ω·cm in volume resistivity.

The shape of the carbon member may be a filament, a plate, a block, a film, a rod, a tube, a mesh, a pyramid, a cone, or woven fabric. The raw material of the carbon member is preferably at least one selected from carbon fiber-reinforced plastic (hereafter abbreviated as CFRP), an expanded graphite sheet, carbon fiber cloth, and a graphite material. In the present invention, any molded product made of carbon fiber may be used, such as carbon fiber woven fabric, carbon fiber knitted fabric, or non-woven fabric.

In particular, the surface roughness of the above-mentioned carbon members is preferably not less than 0.5 μm in arithmetic mean roughness (Ra: JIS B0651/01), for enhanced seed collection efficiency. Though the roughness can be adjusted by polishing, grinding, or the like, the surface of the carbon member may be formed as a concave-convex surface or a surface having fine pores.

The surface roughness is more preferably not less than 1 μm. The roughness may be partially changed based on the current of the ocean, etc., depending on the installation location.

The iron member used in the present invention contains metallic iron such as pure iron. Any iron member (including steel) having a carbon content of not greater than 10 mass % may be properly used in the present invention, such as an iron nail, an iron net, an iron and steel slag, soft iron, iron steel, pig iron, cast iron, or a rolling scale. The iron member may be an iron base alloy containing not less than 50 mass % metallic iron whose carbon content is not greater than 10 mass %.

The iron member containing metallic iron in the present invention more preferably has an Fe content of not less than 5 mass %, from the view point of iron elution velocity and stability. The iron member may be pure iron.

In the present invention, the carbon member and the metallic iron in the iron member are at least partly in contact with each other, thus constituting the egg settlement inducing substrate according to the present invention. The structure in which the iron member containing metallic iron has a planar shape and is situated at the center of the egg settlement inducing substrate and the carbon member having a mesh-like shape is arranged on the outer periphery of the iron member or the structure in which the binding member is further placed around the former structure is preferable as the form of installation in seawater.

The structure in which the iron member containing metallic iron has a cylindrical shape and is situated at the center of the egg settlement inducing substrate and the carbon member having at least one shape selected from a strip, a mesh, a line, and a rod is arranged on the outer periphery of the iron member or the structure in which the binding member is further placed around the former structure may also be used as the form of installation in seawater. Further, the iron member may be shaped like a pinholder, and the iron member and the carbon member may be both shaped like a rod.

As a specific usage pattern, for example, a rodlike iron member and tubular carbon fiber woven fabric are used. By hanging the iron member and the carbon member in the longitudinal direction, the iron member and the carbon member can be constantly kept in contact with each other by the action of gravity.

As an alternative, semicircular CFRP (CFRP shaped like watershoot used for roofs) is horizontally placed, and an iron rod is placed in the CFRP. In this way, too, the metallic iron in the iron member and the carbon member can be constantly kept in contact with each other.

As another alternative, an iron rod is vertically inserted in funnel-shaped CFRP. In this way, too, the metallic iron in the iron member and the carbon member can be constantly kept in contact with each other.

In the present invention, a self-shrinkable lashing member may be further wrapped around the structure of the iron member and the carbon member or the structure of the iron member, the carbon member, and the binding member. In the case where the binding member is self-shrinkable, the binding member can also serve as a lashing member. Pressure bonding may also be performed by wrapping carbon fiber woven fabric around a cylindrical rodlike iron member and tying them with a thin rubber cord, rubber tape, a rubber tube, or extendable and/or elastic plastic tape.

The lashing member may be a pressure bonding member which is a unity band used to fix the iron member, the carbon member, and the binding member together.

The shape of the egg settlement inducing substrate according to the present invention is preferably selected from a plate, a pyramid, a cone, a sheet, a rod, a cradle, and the like. These are mere examples, and various shapes may be used depending on the conditions such as the tide in the egg settlement inducing substrate installation location.

A combination of the iron member containing metallic iron and the carbon member may serve as a water purifier (see Patent Literature (PTL) 1). In the present invention, however, very high seed collection efficiency can be attained by providing the carbon member on the outer periphery of the iron member. As a result, the egg settlement inducing substrate may be installed even in an area where natural seed collection has conventionally been impossible. In addition, the time for the egg settlement inducing substrate installation does not depend on the time of spawning and emergence of juvenile larvae, which significantly simplifies the management of the time for the installation.

Though the reasons for these advantageous effects are not completely clear, the present inventors have the following opinion.

In the case where an iron member and a carbon member are simply combined, the iron component in the iron member dissolves to give bivalent iron ions which change to trivalent iron ions over time, and eventually become iron oxide or iron hydroxide, thus degrading the state of contact between the iron member and the carbon member and decreasing the purification effect. The entry of sand, mud, and the like from outside may also cause degraded functioning.

In the egg settlement inducing substrate according to the present invention, on the other hand, an iron plate or iron member is inserted in bag-like carbon fiber woven fabric, and a binding member is provided outside this structure. This ensures the contact between the carbon member and the iron member, and suppresses the above-mentioned adverse effects.

Eggs produced from shellfish or larvae after fertilization drift in the sea and eventually attach to an object. In the case of oysters, for example, their eggs or larvae attach to scallop shells, palm leaves, brush-like objects made of plastic, or the like. To produce active eggs, parent oysters or parent shellfish need to be active and healthy. It is therefore necessary that plankton which parent oysters or parent shellfish prey on are abundant. In other words, iron is essential to sustain spawning, i.e. the ultimate activity for an organism to leave offspring in the future.

Plankton of good quality requires good chlorophyll and iron essential for generating the chlorophyll. An organism in spawning state especially needs plankton of good quality.

Accordingly, in any case, the egg settlement inducing substrate having the iron supply function as in the present invention effectively realizes spawning and egg settlement.

Phenomena of egg attaching on a carbon member have been recognized, including spawning of killifish in a tank experiment in a laboratory and spawning of crucian carp in Harunako Lake (PTL 2). The egg attaching effect by contact between an iron member and a carbon member, on the other hand, has never been recognized so far.

The egg settlement inducing substrate according to the present invention can continuously release iron ions, so that the growth environment for oysters is well-prepared. Moreover, the production of plankton which oysters feed on is activated, thus facilitating the growth of oysters and increasing the number of oyster eggs released. Iron is essential for the growth of oysters and oyster eggs, and contributes to favorable growth of eggs and larvae in the settlement period.

The presence of iron thus forms a virtuous circle. In detail, not only a large number of eggs of good quality are produced, but also the bioaffinity of the carbon member contributes to favorable wettability between the carbon member and the eggs, creating an environment in which eggs or larvae of shellfish (e.g. oysters) can attach to the egg settlement inducing substrate (enabling seed collection) even when other objects attach to the egg settlement inducing substrate. Moreover, since a biofilm is formed, the eggs or larvae which have once attached to the egg settlement inducing substrate are effectively kept from falling off.

In the present invention, the operations from shellfish seed collection to culture can all be conducted in the same area by hanging down the egg settlement inducing substrate for shellfish according to the present invention in seawater using a preserve shelf or the like, as illustrated in FIG. 1. Note that the seed collection location and the culture location need not be the same, and the egg settlement inducing substrate may be moved as appropriate.

This culture method has the following advantages.

(1) The egg settlement inducing substrate according to the present invention not only provides a higher egg settling function than scallop shells as the existing egg settlement inducing substrate, but also has shape flexibility and can be repeatedly used.

(2) While the existing egg settlement inducing substrate (e.g. scallop shells) needs to be installed immediately before the release of oyster eggs to enable egg settlement, the egg settlement inducing substrate according to the present invention can achieve sufficient egg settlement even when installed months before the release of oyster eggs.

(3) The egg settlement inducing substrate has nutritional (iron, zinc) support ability for the growth of oysters.

(4) The egg settlement inducing substrate can grow phytoplankton which oysters feed on.

(5) The above-mentioned advantageous effects can be obtained with no particular use of energy.

(6) Even in an area where seed collection of shellfish such as oysters has conventionally been not performed, the steps of egg release, egg settlement, and growth can be realized and so the shellfish can be cultured.

The advantageous effect (6) especially indicates that the high seed collection rate of the egg settlement inducing substrate according to the present invention enables oyster seed collection even in an area where oyster eggs or the like have never settled before, as described in the examples described later. This creates a possibility that new shellfish culture sites emerge more and more, constituting a breakthrough in the shellfish culture industry.

For the installation of the egg settlement inducing substrate according to the present invention, the water depth of installation, the ocean current, the optimal installation density between egg settlement inducing substrates, and the like may be chosen as appropriate.

For the use of the egg settlement inducing substrate according to the present invention, steps and conditions other than those described above, such as the method of suspension in seawater, the culture procedure, and the method of lifting shellfish from seawater, may follow respective ordinary methods.

Larvae of oysters or the like collected using the egg settlement inducing substrate according to the present invention may be removed from the egg settlement inducing substrate or removed together with the carbon member constituting the egg settlement inducing portion, and placed beside the egg settlement inducing substrate (i.e. within the range of iron ion elution from the egg settlement inducing substrate). In this way, new seed collection is performed on the egg settlement inducing substrate (including the case where just the carbon member is newly attached), and also the culture efficiency is improved as iron is supplied and plankton is generated effectively in the iron ion elution range.

In the case of using the zinc coated member, zinc starts to dissolve earlier than iron. The degree of shellfish attachment to various metals increases in the order of silver, nickel, copper, titanium, tin, lead, aluminum, and zinc. Thus, zinc particularly has a function of causing attachment of shellfish among metals.

Regarding the level of concentration of iron or zinc in algae in seawater, iron ions have a higher level of concentration than zinc ions, but even zinc whose level of concentration is lower than that of iron is still capable of much greater concentration than other metals (tin, lead, nickel, etc.). By placing the collected shellfish within the iron ion elusion range, oysters to which zinc is supplied together with iron can be cultured.

The zinc coated iron member placed in seawater does not dissolve immediately, but dissolves over several years. On the other hand, the iron member in contact with the carbon member might dissolve in a relatively short time. For example, when iron rods of 3 cm in diameter wrapped with carbon fiber woven fabric were placed in seawater, some became like a wire of several mm in thickness after one month. The zinc coated iron member has the zinc layer for preventing the iron member from dissolving in seawater. However, when the zinc layer touches the carbon member, carbon and zinc constitute a battery, which eases dissolving as compared with the case where carbon and iron touch each other. Moreover, when the zinc layer is removed, the exposed iron member not only dissolves in seawater but also touches the carbon member, as a result of which the iron dissolves faster.

Shellfish collected in any other location may also be cultured in the above-mentioned iron ion elution range, to culture them with high efficiency.

### EXAMPLES

### Example 1

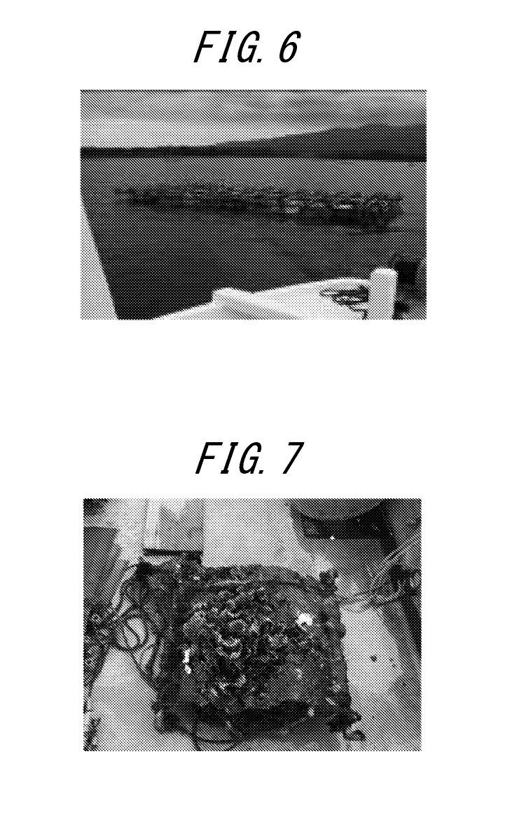

The present inventors suspended egg settlement inducing substrates according to the present invention from an oyster culture raft, in a eutrophic brackish lake (FIG. 6). The settlement of oysters was observed on some parts of the egg settlement inducing substrate 7 months later. The observation was further continued. One year after the placement, oysters grew on all of the placed egg settlement inducing substrates (80 samples) (FIG. 7). The structure of the egg settlement inducing substrates used here includes a bag made of carbon fiber woven fabric (width: 50 cm, height: 60 cm). The sides of the bag were fixed by an adhesive, to keep the carbon fiber woven fabric from fraying. The upper end of the bag was fixed by an adhesive to keep the carbon fiber woven fabric from fraying, with the bag being made into a tube.

An iron plate (thickness: 1.9 mm, height and width: 40 cm×40 cm, mass: 2 kg) was inserted into the bag made of carbon fiber woven fabric. Three holes were made in the upper part of the iron plate using a drill press. To ensure the contact between the iron plate and the carbon fiber woven fabric, a unity band was passed through the carbon fiber woven fabric, the iron plate, and the carbon fiber woven fabric to integrate them. A pipe (made of vinyl chloride) was passed into the tube at the top of the carbon fiber woven fabric, and an L-shaped rod (made of vinyl chloride) was attached to each end of the pipe. A rope for suspension was passed through the pipe at the top of the egg settlement inducing substrate, and the egg settlement inducing substrate was suspended from the raft down to a predetermined position (0.5 m, 1.5 m, 2.5 m, and 3.5 m below the surface of water).

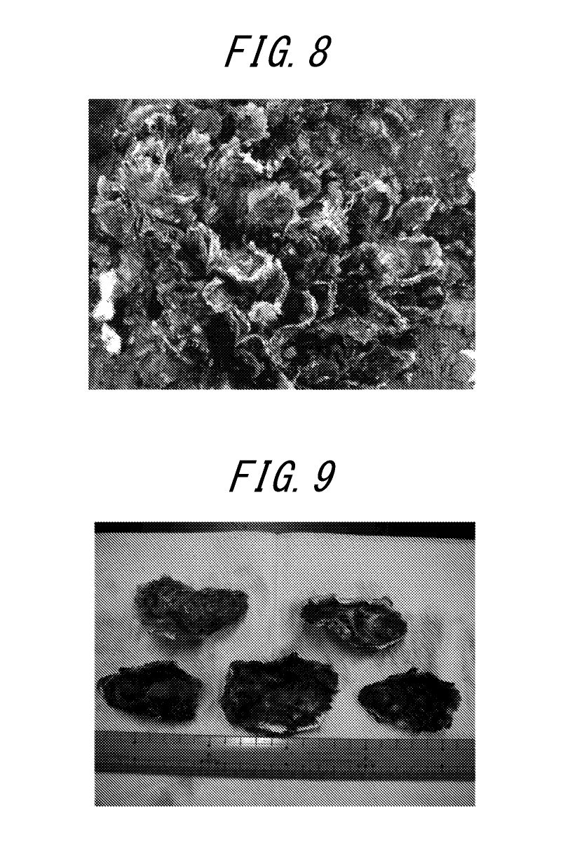

The oysters grown on the egg settlement inducing substrate according to the present invention were evaluated to be about 2 to 3 times larger than those grown by the conventional culture method (method of culturing spat purchased from another location) (FIG. 8).

Regarding the number of settled oysters, while the number is usually at most about 50 in the case of the size (50 cm×50 cm) used in this example, about 200 oysters, large and small, were observed to attach to the egg settlement inducing substrate according to the present invention, demonstrating about a four-fold improvement in settlement density. Some of the oysters were as large as about 7 cm in length and 25 g in mass. FIG. 9 illustrates typical large oysters.

The brackish lake used in this example previously had no phenomenon of natural settlement and growth of oyster eggs, that is, spat purchased from another location were grown in the brackish lake. The result of this example indicates the possibility of a new oyster production site as the series of operations of culturing oysters from eggs, which has conventionally been impossible, is enabled.

### Example 2

The binding member illustrated in FIG. 2 was added to the egg settlement inducing substrate used in Example 1.

The egg settlement inducing substrate using the binding member needed no adjustment of the contact state between the iron member and the carbon member, during the period of implementation of Example 1. The egg settlement inducing substrate used in Example 1, on the other hand, needed the adjustment of the contact state between the iron member and the carbon member every three months. The binding member used here was two rigid sieves made of nylon (opening: 3 cm). The sieves were arranged on both outer sides of the carbon fiber woven fabric in which the iron plate was inserted. The size of each sieve was 60 cm×60 cm. The outer peripheral parts of the two sieves were fixed together by a unity band, integrating the sieve, the carbon fiber woven fabric, the iron plate, the carbon fiber woven fabric, and the binding member.

If there is a gap between the carbon member and the iron member, the interfacial electrochemical reaction is unlikely to occur, and iron is generated only little or not at all.

Besides, barnacles, sea squirts, serpulids, and the like attach between the carbon member and the iron member, and hamper the generation of iron. This example demonstrates that it is preferable to maintain the carbon member and the iron member constantly in contact with each other, and to hold them with the binding member in order to maintain the contact.

### Example 3

A raft for experiment was manufactured on the sea, to research the egg settlement effect of carbon fiber. A tubular mold made of expanded polystyrene was used as a drifting body.

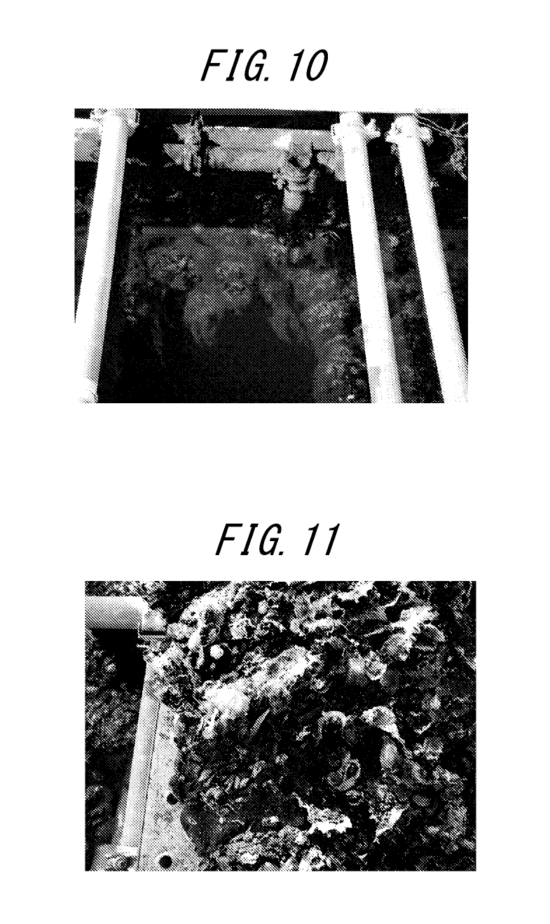

Carbon fiber woven fabric (width: 20 cm, length: 5 m) was used in the research, which was suspended into the sea. The suspension was done by making the upper part of the carbon fiber woven fabric into a tube and passing a zinc-coated iron pipe through it. One month after the placement, the iron pipe from which the carbon fiber woven fabric was suspended became auburn on its surface, and narrowed down like a wire. The iron pipe also corroded and changed into red color, as a result of contact with the carbon fiber woven fabric or seawater (FIG. 10). This indicates that the iron pipe was corroded by seawater and dissolved. The zinc coated iron pipe from which the carbon fiber woven fabric was suspended, upon contact with the carbon member, formed a kind of local battery, as a result of which the zinc layer dissolved first and then the iron dissolved.

Beneath the raft from which the carbon fiber woven fabric was suspended was showed a significant improvement in transparency, and up to 5 m below the surface of the sea was able to be observed. The transparency in seawater where the carbon fiber woven fabric was not suspended, on the other hand, was about 2 m.

Barnacles, lugworms, etc. were observed to attach to the carbon fiber woven fabric suspended into seawater. In particular, a large number of oysters were observed to attach to the parts of frequent contact between the suspended carbon fiber woven fabric and steel member as zinc and the iron member dissolve in large amounts in these parts (FIG. 11).

These experimental results demonstrate the following. The iron member having the zinc coating layer, when immersed in seawater in contact with the carbon member, undergoes a faster zinc layer dissolving phenomenon than in the case where the carbon fiber is not present. Zinc dissolves to generate zinc ions, followed by iron dissolving to generate iron ions. This facilitates the growth of phytoplankton, and creates an active oyster growth environment. In this state, the egg settlement phenomenon occurs due to the bioaffinity of the carbon member.

Other embodiments not described above, such as an iron member shaped like a pinholder, a carbon member shaped like a strip, a line, or a rod, and an egg settlement inducing substrate shaped like a plate, a rod, or a cradle, were confirmed to produce the same excellent advantageous effects as the examples described above, so long as the metallic iron in the iron member and the carbon member are partly in contact with each other. For subsequent growth of spat, it is important to place the spat within the range of iron ion elution of the egg settlement inducing substrate. The spat then grows faster than in other culture methods. The same advantageous effects can be attained even with spat collected in other locations.

As described above, one of the important features of the present invention is that the carbon member and the metallic iron in the iron member are at least partly in contact with each other. The shape, the contact state, and the like may be changed as appropriate, depending on the actual placement conditions of the egg settlement inducing substrate. The use of the zinc coating and/or the binding member provides more advantageous effects.

### INDUSTRIAL APPLICABILITY

The use of the egg settlement inducing substrate for shellfish according to the present invention facilitates stable seed collection of shellfish, and so shellfish can be cultured more simply, easily, and stably than before. The present invention also significantly contributes to a larger number of areas applicable as culture sites, and thus significantly contributes to the development of the culture industry.

1-13. (canceled)

14. An egg settlement inducing substrate for shellfish, comprising:
an iron member containing metallic iron; and
a carbon member constituting an egg settlement inducing portion,
wherein the carbon member is provided on an outer periphery of the iron member so that the carbon member and the metallic iron in the iron member are at least partly in contact with each other.

15. The egg settlement inducing substrate for shellfish according to claim 14,
wherein the shellfish comprises an oyster.

16. The egg settlement inducing substrate for shellfish according to claim 14,
wherein the iron member is at least partly coated with zinc.

17. The egg settlement inducing substrate for shellfish according to claim 14, further comprising
a binding member that binds the carbon member and the iron member together.

18. The egg settlement inducing substrate for shellfish according to claim 17,
wherein the binding member has at least one shape selected from a net, a lattice, and a blind.

19. The egg settlement inducing substrate for shellfish according to claim 14,
wherein the carbon member is made of at least one material selected from charcoal, bamboo charcoal, carbon fiber-reinforced plastic, an expanded graphite sheet, carbon fiber cloth, and a graphite material.

20. The egg settlement inducing substrate for shellfish according to claim 17,
wherein the carbon member is made of at least one material selected from charcoal, bamboo charcoal, carbon fiber-reinforced plastic, an expanded graphite sheet, carbon fiber cloth, and a graphite material.

21. The egg settlement inducing substrate for shellfish according to claim 14,
wherein the carbon member has surface roughness of not less than 0.5 μm in arithmetic mean roughness.

22. The egg settlement inducing substrate for shellfish according to claim 17,
wherein the carbon member has surface roughness of not less than 0.5 μm in arithmetic mean roughness.

23. The egg settlement inducing substrate for shellfish according to claim 14,
wherein the iron member has an Fe content of not less than 5 mass %.

24. The egg settlement inducing substrate for shellfish according to claim 17,
wherein the iron member has an Fe content of not less than 5 mass %.

25. The egg settlement inducing substrate for shellfish according to claim 14,
wherein the iron member has a cylindrical shape and is situated at a center of the egg settlement inducing substrate, and the carbon member has at least one shape selected from a strip, a mesh, a line, and a rod is provided on the outer periphery of the iron member.

26. The egg settlement inducing substrate for shellfish according to claim 17,
wherein the iron member has a cylindrical shape and is situated at a center of the egg settlement inducing substrate, and the carbon member has at least one shape selected from a strip, a mesh, a line, and a rod is provided on the outer periphery of the iron member.

27. The egg settlement inducing substrate for shellfish according to claim 14,
wherein both of the iron member and the carbon member have a rod shape.

28. The egg settlement inducing substrate for shellfish according to claim 17,
wherein both of the iron member and the carbon member have a rod shape.

29. The egg settlement inducing substrate for shellfish according to claim 14, further comprising
a self-shrinkable lashing member wrapping around the members.

30. The egg settlement inducing substrate for shellfish according to claim 17, further comprising
a self-shrinkable lashing member wrapping around the members.

31. A method of collecting shellfish seeds, comprising: suspending the egg settlement inducing substrate for shellfish according claim 14 down to at least one location in any of brackish water and seawater to collect shellfish seeds.

32. A method of culturing shellfish, comprising: placing the shellfish collected by the method according to claim 31 within a range where iron ion eluted from the egg settlement inducing substrate for shellfish according to claim 14 reaches.
